(19) United States
(12) Patent Application Publication
(10) Pub. No.: US 2007/0279328 A1
(43) Pub. Date: Dec. 6, 2007

(54) VIDEO DISPLAY DEVICE, DRIVER FOR VIDEO DISPLAY DEVICE, AND VIDEO DISPLAY METHOD

(76) Inventors: Naoki Takada, Yokohama (JP); Hiroyuki Matsushima, Yokosuka (JP); Yasuyuki Kudo, Fujisawa (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/753,097

(22) Filed: May 24, 2007

(30) Foreign Application Priority Data
May 29, 2006 (JP) 2006-147982

(51) Int. Cl. G09G 3/28

(52) U.S. Cl. 345/63

(57) ABSTRACT

Display data for a current frame is compared with display data for an immediately previous frame, or display data for a current line is compared with display data for an immediately previous line. The input display data is converted, based on a result of the comparison and by referring to a conversion table, to data for an address operation during an address period or address periods for one or a plurality of sub-fields to be scanned first within a frame, or to data for an address operation during an address period or address periods for one or a plurality of sub-fields to be scanned first within a line. Based on the converted data, display discharge is performed after cells in each sub-field are discharged for an address operation to provides video displays having a gray scale level corresponding to an average light emission times in two frames or in two lines.

### 2. CLAIM OF PRIORITY

The present application claims priority from Japanese application serial No. P2006-147982, filed on May 29, 2006, the content of which is hereby incorporated by reference into this application.

### 3. BACKGROUND OF THE INVENTION

The present invention related to a video display device, and more particularly to a video display device such as a plasma display device that provides video displays with a sub-field.

Recently, thin video display devices such as a plasma display device (referred to as PDP device hereinafter) have been put into practical use. For instance, in a case of the PDP device, light is emitted from pixels on a screen of a display panel (plasma display panel: PDP) according to display data. In this device, a pair of electrodes are formed in the inner side of a front glass substrate, and a discharge gas is included inside thereof. When a voltage is applied to a section between the electrodes, planar discharge occurs on surfaces of dielectric layers and protecting layers of the electrodes to generate ultraviolet rays. Because of the ultraviolet rays, excitation emission occurs in red, blue, and green fluorescent materials applied on a rear surface glass substrate to provide display of images.

FIG. 11 and FIG. 12 are views each illustrating a structure of a display panel of a PDP device. The display panel structure has been put into practical use as a conventional technique, and also the present invention is described below on the assumption that a display section has the display panel structure. It is to be noted that the present invention is not limited only to a display section having the display panel structure.

In FIG. 11 and FIG. 12, reference numeral 7 denotes a display panel; 12, a front glass substrate; 15, a transparent electrode for an X-electrode; 16, a bus electrode for an X-electrode; 21, an X-electrode provided on the front glass substrate; 13, a transparent electrode of a Y-electrode; 22, a Y-electrode provided on the front glass substrate 12; 20, a rear glass substrate; 19, a fluorescent material applied on the rear glass substrate; 17R, 17G, 17B, address electrodes provided on the rear glass substrate 20; and 18, a partition wall. A dielectric layer (not shown) and a protecting layer (not shown) are provided on each of the X-electrode 21 and the Y-electrode 22. Furthermore, a discharge cell is formed between the front glass substrate 12 and the rear glass substrate 20 with a space in which a discharge gas is filled and partitioned with the partition wall 18. There are provided a plurality of X-electrodes 22 and a plurality of Y-electrode 22 respectively, and the plurality of electrodes are provided in parallel to each other. Also there are provides a plurality of address electrodes 17R, 17G, and 17B, and the plurality of electrodes (Al to Am) extends in a direction orthogonal to the X-electrode 21 and to the Y-electrode 22.

FIG. 13 is a view illustrating an example of a driving sequence for the PDP device.

In the driving sequence for the PDP device, a one frame constituting a screen is configured with a plurality of sub-fields SF1 to SFn. Each sub-field has a predetermined weight for brightness and performs a predetermined gray scale display depending on the weights for brightness. For instance, 256 types of gray scale displays are provided for images with discharge ratios of 1:2:4:8:32:64:128 in 8 sub-fields SF1 to SFn each having a weight for brightness defined by a factorial function of 2. Each sub-field is defined with a reset period Tr for homogenizing wall charges in all cells, an address period Ta for selecting a cell to be lit for displaying an image, and a sustain period Ts for generating discharge from the selected cell for the image display by the number of discharge times which is corresponding to required brightness. A cell in each sub-field is lit according to the brightness, and a 1-frame display is provided with the n sub-fields.

FIG. 14 is a block diagram illustrating an example of a PDP device using the display panel shown in FIG. 11.

In FIG. 14, reference numeral 1 denotes a data converting circuit for converting display data for input video signals to display data based on the sub-field system which can be shown on a display panel 7; 2, a memory; 3, a an address-side driver as a cell drive circuit for driving each of the address electrodes on the display panel 7; 5, a Y-side driver as a cell drive circuit for driving each of the Y-electrodes on the display panel 7; 6, an X-side driver for driving each of the X-electrodes on the display panel 7; and 4, a drive control circuit for controlling each of the drivers 3, 5, and 6. Display data D for brightness levels for three colors of red, blue, and green, a vertical sync signal Vsync indicating state of 1 frame, a horizontal sync signal Hsync indicating start of 1 line, a clock signal CLK are inputted from a TV tuber or the like to the drive control circuit 4. The drive control circuit 4 generates write/read signals to and from a memory 2 in synchronization with the vertical sync signal Vsync and the horizontal sync signal Hsync. Also the drive control circuit 4 generates a rest timing signal for generation of a rectangular voltage Vx or a saw voltage Vr, a scan timing signal for generating a line selection voltage Vay described later, a sustain timing signal for generation of sustain voltages Vsx, Vsv, and the like in synchronization with the vertical sync signal Vsync and the horizontal sync signal Hsync. The data converting circuit 1 converts input display data D to display data based on the sub-field system according to a preset conversion table.

FIG. 15 is a view illustrating data conversion in the data converting circuit 1. FIG. 15 is a view illustrating a case in which image display is provided using 8 sub-fields SF1 to SF8. For instance, when the display data for an inputted video signal (digital video signal) is “00000100”, an address is selected in the sub-field SF3, and the number of discharge times is 4 times (a relative value, and all the number of the discharge times in the following descriptions are relative values) in this case. With this operation, an image with the gray scale level of “4” is displayed. In response to a write signal from the drive control circuit 4, an output from the data converting circuit 1 for one screen is written in the memory 2. After the output for one screen is written in the memory 2, the output is divided to each bit digit to provide data for each sub-field. Furthermore, in response to a read signal from the drive control circuit 4, an address selection pulse Va described later is supplied for one line to an address side driver 3.

FIG. 16 is a view illustrating an example of a drive waveform in a PDP device shown in FIG. 14. During the reset period Tr, an X-side driver 6 supplies the X-electrode with the rectangular voltage Vx, while a Y-side driver 5 supplies a saw voltage Vr to the Y-electrode to remove wall charges in all cells for resetting the charged state in the cells. During the address period Ta, the Y-side driver 5 applies a line selection voltage Vay to the Y-electrode, while the X-side driver 6 applies the rectangular voltage Vax to the X-electrode, and also applies an address section pulse Va to a cell to be lit based on the display data to accumulate the wall charges caused by an address discharge. The line selection voltage Vay is applied by shifting the timing for each line. During the sustain period Ts, sustain voltages Vsx, Vsy are applied to the X-electrode and the Y-electrode by the number of discharge times corresponding to the brightness to light a cell in which wall charges are accumulated because of the address discharge.

U.S. Pat. No. 6,636,187 (JP-A-11-282398) discloses a conventional technique to which the present invention pertains and which is described in a Patent document, for instance, in. The U.S. Pat. No. 6,636,187 discloses the technique for scanning lines to reduce a current and power consumed by the address side driver 3 without causing degradation of image quality. In the technique, a plurality of the orders of scanning lines are prepared, and a predetermined order is selected from the plurality of the orders for scanning lines.

### 4. SUMMARY OF THE INVENTION

In the display panel 7 in FIGS. 11, 12 and 14, when discharge occurs during the sustain period in a cell, primary particles are generated in the cell space. As the time passes by after generation of the primary particles, the primary particles are reduced. As the number of primary particles decreases, the time from application of an address selection pulse during the address period until occurrence of an address discharge becomes longer. In the PDP device described above with reference to C to FIG. 16, for instance, the time until occurrence of an address discharge in the fourth sub-field (SF4) in the gray scale level of “9” is shorter than that in the case of the gray scale level of “8”. In other words, in the case of the gray scale level of “9”, an address is selected in the first sub-field (SF1), and discharge is performed in the first sub-field (SF1) during the sustain period, while, in the case of the gray scale level of “8”, an address is selected in the fourth sub-field and discharge is performed in the fourth sub-field during the substain time. Therefore the time until an address discharge is performed is longer at the gray scale level “9” as compared to that in the case of gray scale level “8”. It is necessary to set an address period at a longer time by taking into considerations the fact that address discharge is performed in each sub-field. Recently a resolution degree of images on a screen of a video display device has been becoming increasingly higher, and in association with the tendency above, the number of display lines has been becoming larger, and therefore an address period has been becoming longer and a sustain period has been becoming shorter with the number of sub-fields also being reduced. The shorter the sustain period becomes, the lower brightness of an image is. In addition, reduction in the number of sub-fields causes lowering of a gray scale level of images, which results in degradation f video displays.

The present invention was made to solve the problem as described above by suppressing fluctuation of a discharge time so that an address discharge is made accurately in the stable condition when accessing an address and an address period is shortened.

An object of the present invention is to provide, by achieving the objective as described above, a video display technique enabling suppression of degradation of displayed image quality.

To achieve the technical objective as described above, in a video display device according to the present invention, display data for an inputted current frame is compared with display data for the immediately previous frame, or display data for a current line is compared with display data for the immediately previous line; the display data for inputted video signal is converted. Based on the result of the comparison above as well as a preset conversion table, the display data for the inputted image signal is converted to data for addressing a cell within an address period or address periods for one or a plurality of sub-fields which are scanned first within a frame, or data for addressing a cell within an address period for one or a plurality of sub-fields which are scanned first within a line. Based on the converted data, an address discharge is performed for each sub-field based. The cell for which the address discharge is performed is discharged for display to provide video displays. With the configuration as described above, the displayed image has a gray scale level based on the average number of times of emission of cells in two frames, or on the average number of times of emission of cells in two lines.

With the present invention, it is possible to shorten an address period and also to suppress degradation of video displays.

### 5. BRIEF DESCRIPTION OF THE DRAWINGS

FIG. 1 is a block diagram illustrating an example of a video display device according to a first embodiment of the present invention;

FIG. 2 is a view illustrating a signal waveform in a frame detection circuit in the video display device shown in FIG. 1;

FIG. 3 is a view illustrating an example of a data conversion table in a data conversion circuit in the video display device shown in FIG. 1;

FIG. 4 is a view illustrating a drive sequence for the video display device shown in FIG. 1;

FIG. 5 is a view illustrating an example of the data conversion table in the data conversion circuit in the video display device shown in FIG. 1;

FIG. 6 is a view illustrating another example of the data conversion table in the data conversion circuit in the video display device shown in FIG. 1;

FIG. 7 is a view illustrating still another example of the data conversion table in the data conversion circuit in the video display device shown in FIG. 1;

FIG. 8 is a block diagram illustrating a video display device according to a second embodiment of the present invention;

FIG. 9 is a view illustrating a wave form in each section of a line detection circuit in the video display device shown in FIG. 8;

FIG. 10 is a view illustrating a data conversion table in the data conversion circuit in the video display device shown in FIG. 8;

FIG. 11 is a view illustrating a display panel structure of a conventional PDP device;

FIG. 12 is a view illustrating a display panel structure of the conventional PDP device;

FIG. 13 is a view illustrating an example of drive sequence in the conventional PDP device;

FIG. 14 is a view illustrating an example of a configuration of the conventional PDP device;

FIG. 15 is a view illustrating data conversion in the data conversion circuit in the conventional PDP device; and

FIG. 16 is a view illustrating an example of a drive waveform in the conventional PDP device.

### 6. DETAILED DESCRIPTION OF THE PREFERRED EMBODIMENT

Embodiments of the video display device according to the present invention are described with reference to the accompanying drawings. The video display device according to the present invention is, for instance, a PDP device, which provides gradated video displays by making a cell as a pixel of a display section emit light by each sub-field.

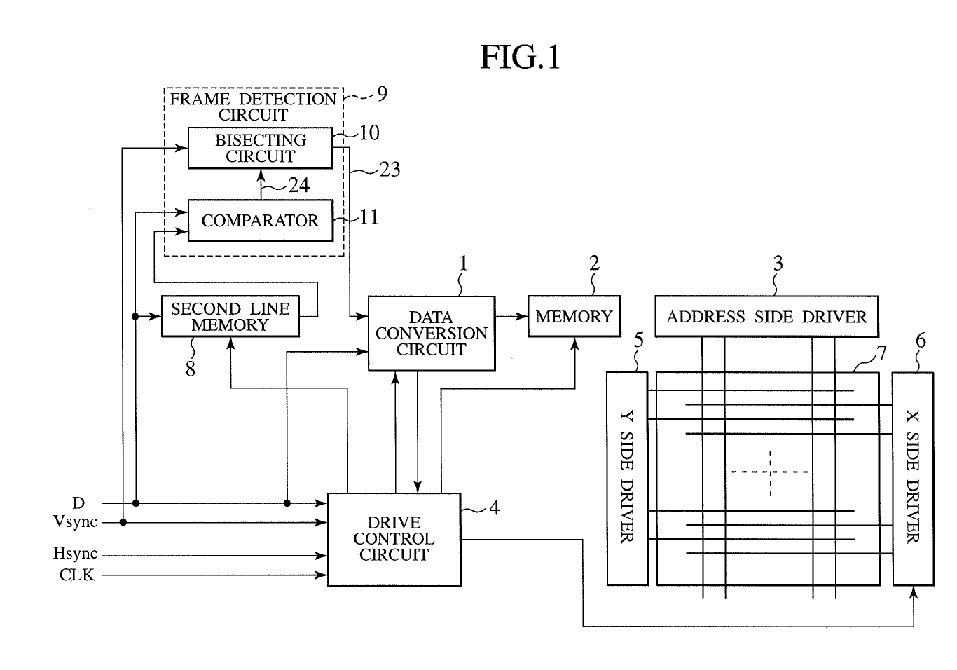

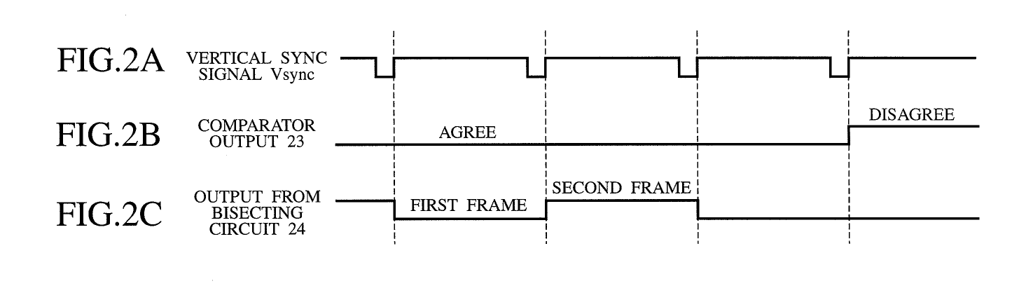

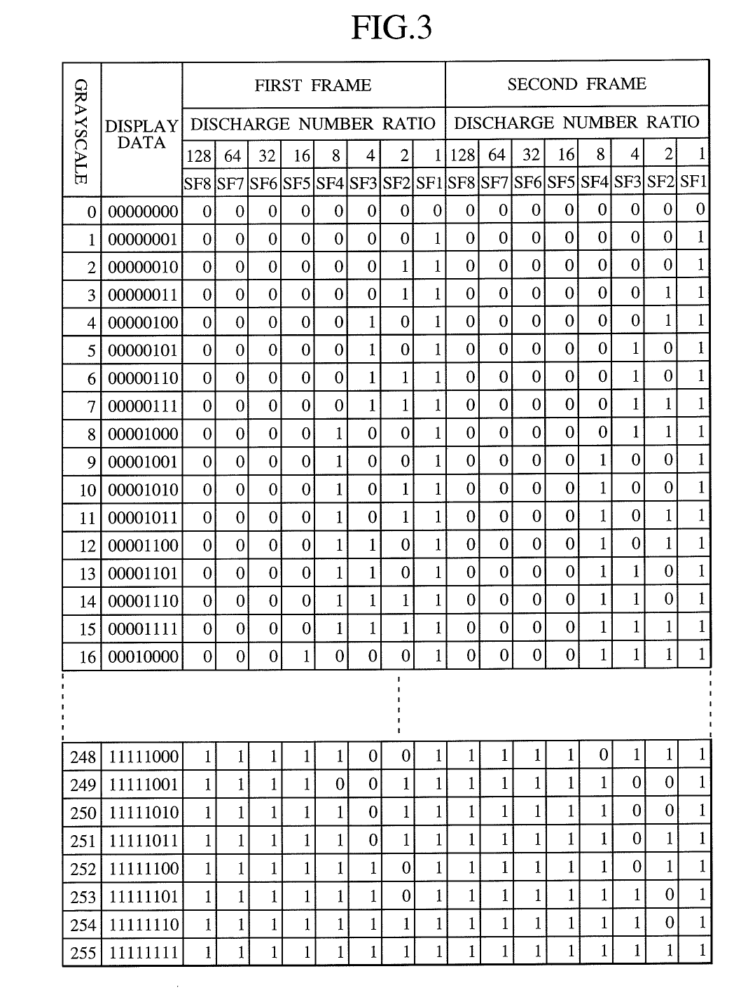

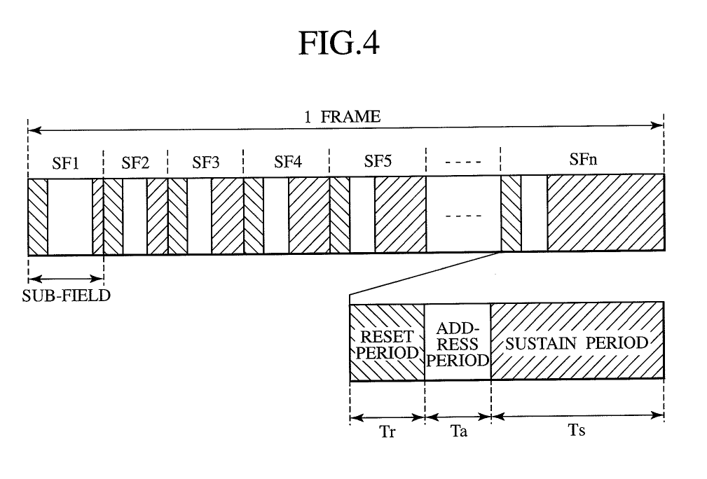

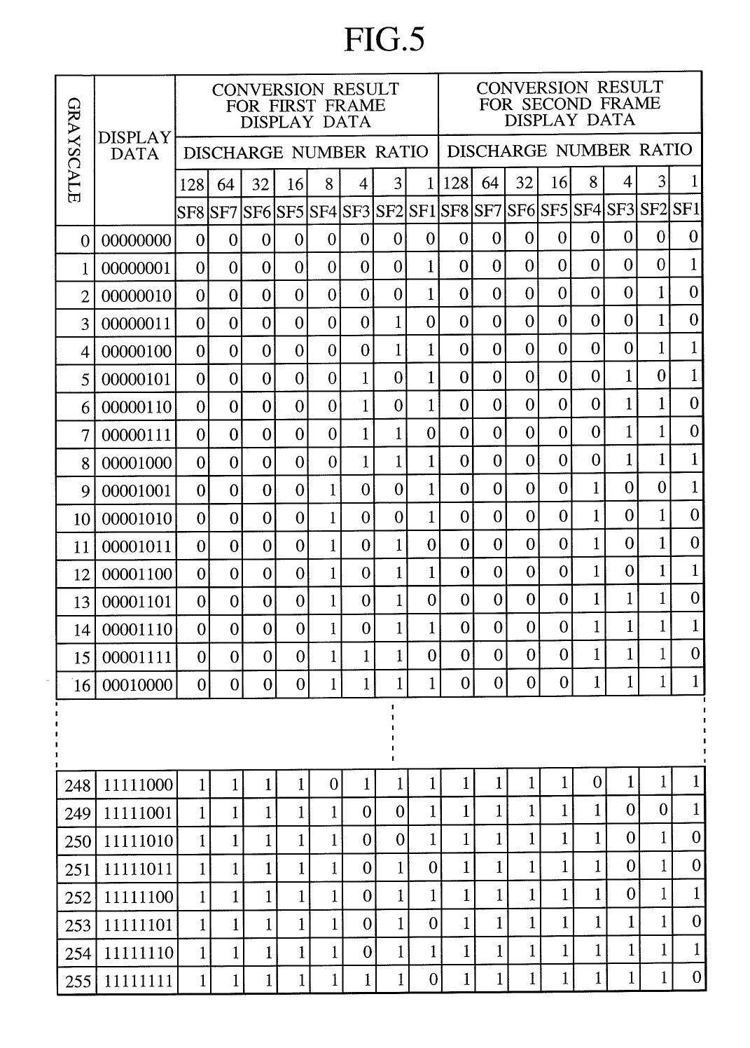

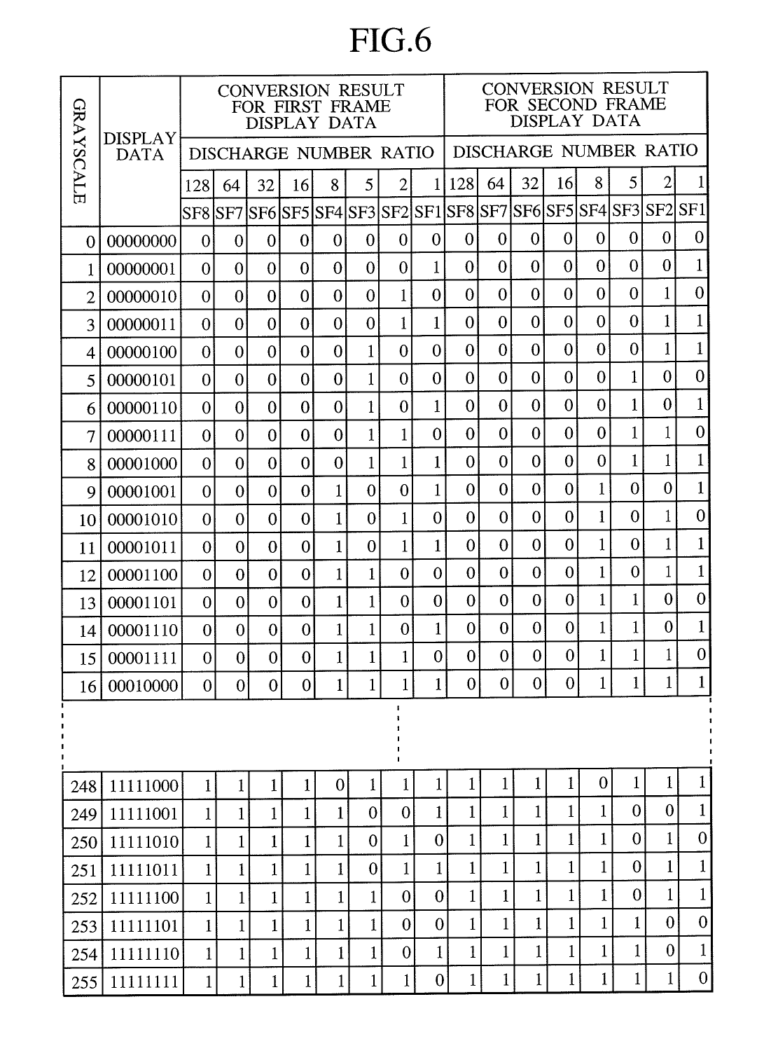

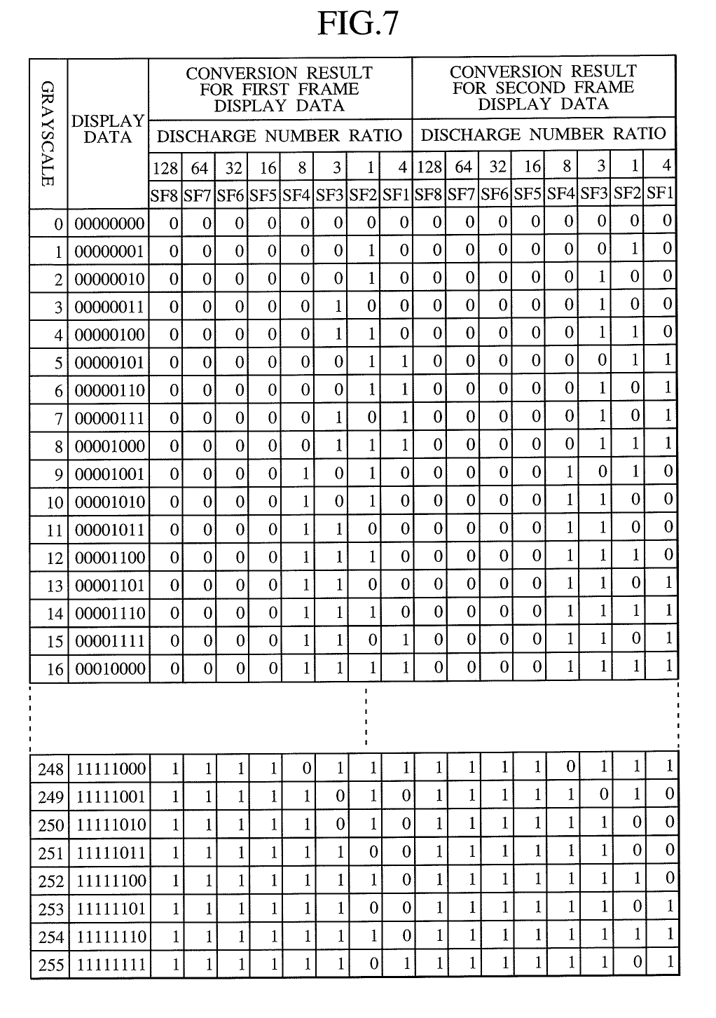

FIG. 1 to FIG. 7 are views each illustrating a video display device according to a first embodiment of the present invention. FIG. 1 is a view illustrating an example of a video display device according to the first embodiment of the present invention; FIG. 2 is a view illustrating an output waveform from a frame detection circuit in the video display device shown in FIG. 1; FIG. 3, FIG. 5, FIG. 6, and FIG. 7 are views each illustrating a data conversion table (described as a conversion table hereinafter) in a data conversion circuit in the video display device shown in FIG. 1; and FIG. 4 is a view illustrating a drive sequence in the video display device shown in FIG. 1.

In the video display device according to the first embodiment of the present invention, display data for an inputted video signal is converted to data specified so as to enable an address operation during an address period for one or a plurality of sub-fields to be scanned first within a frame, the cells to be lit are driven for an address discharge as well as for a display discharge for each sub-field based on the converted data to display an image having a gray scale level corresponding to an average emission times of the cells in two successive frames. In this example, cells displaying any color other than black, namely cells to be lit are discharged during address periods for one or a plurality of sub-fields to be scanned first within the frame, and the address discharge is performed in the state where primary particles within the cell space still remain and an address discharge can be performed without fail with fluctuation of a discharge period sufficiently suppressed. By performing an address discharge without fail in the state where fluctuation of the discharge period is suppressed, it is possible to shorten an address period for each sub-field. When the address period is shortened, any specific operation for shortening the sustain period is not required, and also reduction of the number of sub-fields is unnecessary, so that degradation of image quality can be prevented. Description is provided below for a case where a PDP device is used as a video display device.

In FIG. 1, reference numeral 7 denotes a display panel as a display section including cells formed at crossing points of matrix; 1, a data conversion circuit for converting display data for an inputted video signal to display data based on the sub-field system which can be displayed on the display panel 7; 2, a memory as a storage unit; 3, an address side driver as a cell drive circuit for driving each address electrode on the display panel 7 or an address electrode drive circuit; 5, a Y-side driver for driving each Y-electrode on the display panel 7 or a display electrode drive circuit; 6, an X-side driver as a cell drive circuit for driving each electrode on the display panel 7 or a display electrode driver circuit, and 4, a drive control circuit as a control circuit for controlling the drivers 3, 5, 6, the memory 2, the data conversion circuit, and other related sections. Inputted to the drive control circuit 4 are display data D indicating brightness levels of three colors if red, blue, and green, a vertical sync signal Vsync indicating start of 1 frame, a horizontal sync signal Hsync indicating start of 1 line, a clock signal CLK and the like from a TV tuner or other related sections. The drive control circuit 4 generates write/read signals for the memory 2 in synchronization with the vertical sync signal Vsync or the horizontal sync signal Hsync. Furthermore, the drive control circuit 4 generates a reset timing signal for generating a rectangular voltage Vx or a saw voltage Vr, a scan timing signal for generating a line selection voltage Vay, a sustain timing signal for generating a sustain voltages Vsx, Vsy in synchronism with the vertical sync signal Vsync and the horizontal sync signal Hsync.

Furthermore, reference numeral 9 denotes a frame detection circuit for detecting a first frame or a second frame among the two successive frames; 10, a bisecting circuit for bisecting the vertical sync signal Vsync in the frame detection circuit 9; 8, a second memory; 11, a comparator provided in the frame detection circuit 9 for comparing output from the second memory 8 to display data D; 23, an output from the comparator 11; and 24, an output from the bisecting circuit 10. When it is determined as a result of comparison in the comparator 11 that an output from the second memory at the same address in one frame is different from the display data D, the comparator 11 resets the bisecting circuit 10 to restore to the original state of the first frame. The drive control circuit 4 controls the data conversion circuit 1 and the memory 2. Namely, the drive control circuit 4 controls the data conversion circuit 1 so that the data conversion circuit 1 converts, based on a result of comparison by the comparator 11 and on the conversion table, the display data D to data for addressing a cell on the display panel 7 within an address period for one or a plurality of sub-fields to be scanned first within a frame. Also the drive control circuit 4 controls the memory 2 so that the converted data is stored in the memory 2 and so that an address selection pulse is outputted during an address period for the one or the plurality of sub-fields specified in the converted data.

The data conversion circuit 1 converts inputted display data d to display data based on the sub-field system by referring to a preset conversion table. The data conversion circuit 1 has two conversion tables. The two conversion tables are as shown in FIG. 3, FIG. 5, FIG. 6, and FIG. 7, and are divided to two successive frames in use.

In the following description, the same reference numerals are assigned to the same components as those shown in FIG. 1.

FIG. 2 is a view for illustrating a signal waveform in each section of the frame detection circuit 9 in the video display device shown in FIG. 1.

In FIG. 2, FIG. 2A shows a vertical sync signal Vsync; FIG. 2B, an output 23 from the comparator 11; and FIG. 2C, an output 24 from the bisecting circuit 10. The output 24 from the bisecting circuit 10 is provided in response to the vertical sync signal Vsync so that the signal voltage is low (described as “L” below) in the first frame of the two successive frames and “high” (described as “H” below) in the second frame. The output 23 from the comparator 11 is provided as “H” when the display data D and an output from the second memory 8 are not identical, that is, when display data D for the current frame and display data for the immediately previous frame outputted from the second memory 8 are not identical. In addition, the output 23 is provided as “L” when the display data D and an output from the second memory is identical, that is, when display data for the current frame and display data for the immediately previous frame outputted from the second memory 8 are identical to each other.

FIG. 3 is a view illustrating an example of a conversion table in the data conversion circuit 1 in the video display device shown in FIG. 1, and this example corresponds to a case where a first address section performed in two successive frames (a first frame and a second frame) is performed on one sub-field to be scanned first in each frame. FIG. 3 illustrates a case in which video displays are provided using 8 sub-fields SF1 to SF8. In FIG. 3, the sub-field scanned first is the sub-field SF1 at the lowermost position (with the lowermost weight of brightness and the shortest sustain period).

In FIG. 3, for instance, when display data D (digital data) at an address on the current frame is “00000110” and display data at the address on the immediately previous frame outputted from the second memory 8 is “00000110”, the output 23 from the comparator 11 in the frame detection circuit 9 is “L” because the display data for the current frame and display data for the immediately previous frame outputted from the second memory 8 are identical. Furthermore, when the output 24 from the bisecting circuit 10 in the frame detection circuit 9 is “L”, results of data conversion at this address in the sub-fields SF8 to SF1 are 0:0:0:0:0:1:1:1 respectively. Since a ratio of the numbers of times of discharges is set at 128:64:32:16:8:4:2:1 for the sub-fields SF8 to SF1 respectively, the number of discharge times for the converted display data is totally 7 times. In this step, after display data for an immediately previous frame is read out, the display data for the current screen (frame) is written in the second memory 8. When the display data at the address in the following frame is also “00000110”, the output 23 from the comparator 11 is “L”, and the output 24 from the bisecting circuit 10 in the frame detection circuit 9 is “H” in the second frame. Therefore, results of data conversion at the address in the sub-fields SF8 to SF1 are 0:0:0:0:0:1:0:1 respectively, and the discharge times is 5 times in all. In this case, the number of discharge times is switched frame by frame, and the average gray scale is 6 (namely, (7+5)/2), and therefore the display image is at the gray scale level “6”.

Furthermore, when display frame for a screen is switched, for instance, when the display data is changed to “00001000” after processing for the first frame is finished, since an input from the comparator 11 in the frame detection circuit 8 is different from the display data “00000110” for the immediately previous screen (frame) outputted from the second memory 8, the output 23 from the comparator 11 is “H”, while the output 23 from the bisecting circuit is “L” in the first frame. In this case, result of data conversion by the data conversion circuit 1 at this address in the sub-fields SF8 to SF1 is 0:0:0:0:1:0:0:1 respectively, and therefore the number of discharge times is 9 in total. Also in this case, the discharge time is switched frame by frame, and the average gray scale level is 7 (namely, (5+9)/2), and the displayed image is at the gray scale level “7”.

As shown in FIG. 3, a first address selection within a frame is performed at the lowermost sub-field SF1 which is scanned first among two successive frames (a first frame and a second frame). Therefore, even in a cell primary particles have decreased after passage of time from a time point of discharge within a sustain period, discharge is performed during the sustain period at the lowermost sub-field SF1. Because of the feature, the delay of an address discharge in each of the other sub-fields SF2 to SF8 is reduced, and the address period in each of the sub-fields SF2 to SF8 is shortened.

FIG. 4 is a view illustrating a drive sequence in the video display device shown in FIG. 1.

In the video display device shown in FIG. 1, a first address section in two successive frames (a first frame, and a second frame) is performed in the sub-field SF1, which is scanned first and at the lowermost position (with the lowermost weight for brightness and the shortest sustain period) as shown in the conversion table in FIG. 3. Because of the feature, in the drive sequence in the video display device shown in FIG. 1, an address period is set long only for the sub-field SF1 and is set short for each of the remaining sub-fields SF2 to SF8. Because the address period is shortened, the sustain period becomes longer proportionately. When the sustain period becomes longer, a brightness level of an image becomes higher, which enables display of a bright image. Furthermore, when the address period becomes shorter, the number of sub-fields increases. Increase in the number of sub-fields enables increase in gray scale levels for images.

FIG. 5, FIG. 6, and FIG. 7 are views illustrating other examples of the conversion table in the data conversion circuit in the video display device shown in FIG. 1, and in the cases, a first address selection within two successive frames (a first frame and a second frame) is performed in some or all of a plurality of sub-fields to be scanned within each frame. Also in the case shown in FIG. 5, FIG. 6, and FIG. 7, video display is provided by using 8sub-fields SF1 to SF8. The plurality of sub-fields correspond to the two sub-fields SF1 to SF2 in the case shown in FIG. 5, and to the three subfields SF1 to SF3 in the cases shown in FIG. 6 and FIG. 7. In the case shown in FIG. 5, the ratio of the number of discharge times for the uppermost sub-field SF8 is 128, while that for the sub-field SF2 is 3. In the case shown in FIG. 6, the ratio of the number of discharge times for the subfields SF3 is 5. In the case shown in FIG. 7, the ratio of the number of discharge times for the sub-fields SF1 is 4, that for the sub-fields SF2 is 1, and that for the sub-fields SF3 is 3. In the case shown in FIG. 5, in the drive sequence in the video display device shown in FIG. 1, address periods for the sub-fields SF1 and SF2 are set long, while those for the other sub-fields SF3 to SF8 are set short. In the cases shown in FIG. 6 and FIG. 7, in the drive sequence in the video display device shown in FIG. 1, address periods for the sub-fields SF1, SF2, and SF3 are set long, while those for the other sub-fields SF4 to SF8 are set short. Also in the cases shown in FIG. 5, FIG. 6, and FIG. 7, it is possible to prolong the sustain period for the sub-fields each with the address period shortened. When the sustain period becomes longer, a brightness level of an image becomes higher, which enables display of bright images. When the address period becomes shorter, also the number of sub-fields is made larger. Increase of sub-fields enables increase in gray scale levels of images.

In FIG. 5, for instance, when display data (digital data) at an address on the current frame is “00000110” and also display data at the current address on an immediately previous screen (frame) outputted from the second memory 8 is “00000110”, because the display data D for the current frame and the display data for the immediately previous frame outputted from the second memory are identical, the output 23 from the comparator 11 in the frame detection circuit 9 is “L”. Furthermore, the output 24 from the bisecting circuit 10 in the frame detection circuit 9 is “L” in the first frame, results of data conversion at the address in the sub-fields SF8 to SF1 are 0:0:0:0:0:1:0:1 respectively. The discharge ratios for the sub-fields SF8 to SF1 are set at 128:64:32:16:8:4:3:1, respectively, and therefore the number of discharge times in the converted discharge data is 5 times in total. After display data or the immediately previous frame is read out, display data D for the current screen (frame) is written by the drive control circuit 4 in the second memory 8. When display data at the address in the following frame is also “00000110”, the output 23 from the comparator 11 is “L”, while the output 24 from the bisecting circuit 10 in the frame detection circuit is “H” in the second frame. Therefore, results of data conversion at the address in the sub-fields SF8 to SF1 are 0:0:0:0:0:1:1:0, respectively, and the number of discharge times is 7 times in total. Therefore, the discharge times is switched frame by frame, and the average gray scale level is 6 (namely, (5+7)/2). In this case, a displayed image has the gray scale level of “6”.

When display data is switched for each screen, for instance, when the display data D is changed to “00001000” after processing for the first frame is over, an input to the comparator 11 in the frame detection circuit 8 is different from the display data “00000110” for the immediately previous screen (frame) outputted from the second memory 8, and therefore the output 23 from the comparator 11 is “H”, while the output 23 from the bisecting circuit 10 is “L”. In this case, results of data conversion at the address in the sub-fields SF8 to SF1 by the data conversion circuit 1 are 0:0:0:0:0:1:1:1, respectively, and the number of discharge times is 8 times in total. Therefore, also in this case, the number of discharge times is switched frame by frame, and the average gray scale level is 7.5 (namely, (7+8)/2). The displayed image has the gray scale level of “7.5”.

As shown in FIG. 5, a first address selection within a frame is performed in the sub-fields SF1 to SF2 which are scanned first within two successive frames (a first frame and a second frame). Therefore, a delay of an address discharge in each of the other sub-fields SF-3 to SF8 is reduced, and address periods for the sub-fields SF3 to SF8 are shortened.

Also in the cases shown in FIG. 6 and FIG. 7, an address period for each of the sub-fields SF4 to SF8 is shortened for the same reason as that described by referring to FIG. 5 above. In FIG. 7, for instance, when display data (digital data) at an address on the current frame is “00000011” and also display data at the address in an immediately previous screen (frame) outputted from the second memory 8 is “00000011”, the display data D for the current frame and the display data for the immediately previous frame outputted from the second memory 8 are identical, and therefore the output 23 from the comparator 11 in the frame detection circuit 9 is “L”. Furthermore, when the output 24 from the bisecting circuit 10 in the frame detection circuit 9 is “L” in the first frame, results of data conversion at the address in the sub-fields SF8 to SF1 are 0:0:0:0:0:1:0:0 respectively. Because the discharge time ratios for the sub-fields SF8 to SF1 are set at 128:64:32:16:8:3:1:4 respectively, the discharge time based on the converted display data is 3 times in all. In this step, after display data for an immediately previous frame is read out, the display data D for the current screen (frame) is written by the drive control circuit 4 at the address in the second memory 8. When display data at the address in the following frame is again set at “00000011”, the output 23 from the comparator 11 is “L”, while the output 24 from the bisecting circuit 10 in the frame detection circuit 9 is “H” in the second frame. Therefore, also results of data conversion at the address in the sub-fields SF8 to SF1 are 0:0:0:0:0:2:0:0 respectively, and the number of discharge times is 3 times in all. As a result, the average gray scale level for the two frames is 3 (namely, (3+3)/2), and the displayed image has the gray scale level “3”.

Furthermore, when display data for a screen is switched, for instance, when the display data changes to “00001000” after processing for the first frame is finished, because an input to the comparator 11 in the frame detection circuit 8 is not identical to the display data “00000011” for an immediately previous screen (frame) outputted from the second memory 8, the output 23 from the comparator 23 is “H”, and the output 23 from the bisecting circuit 10 is “L” in the first frame. In this case, results of data conversion by the data conversion circuit 1 at the address in the sub-fields SF8 to SF1 are 0:0:0:0:0:1:1:1 respectively, and the number of discharge times is 8 times in all. Therefore, the number of discharge times is switched from frame to frame, and the average gray scale level is 5.5 (namely, (3+8)/2). The displayed image has the gray scale level of “5.5”.

As described above, also in the case shown in FIG. 7, a first address selection within the frame is performed in a plurality of sub-fields SF1 to SF3 which are scanned first in two successive frames (a first frame and a second frame). Because of the feature, a delay in an address discharge for each of the other sub-fields SF4 to SF8 is reduced, and the address period for each of the other sub-fields SF4 to SF8 is shortened.

With the first embodiment of the present invention as described above, in the video display device according to the embodiment, an address discharge performed for addressing can accurately be carried out by suppressing fluctuation of the discharge period, which enables shortening of the address period and also enable suppression of degradation in quality of displayed images.

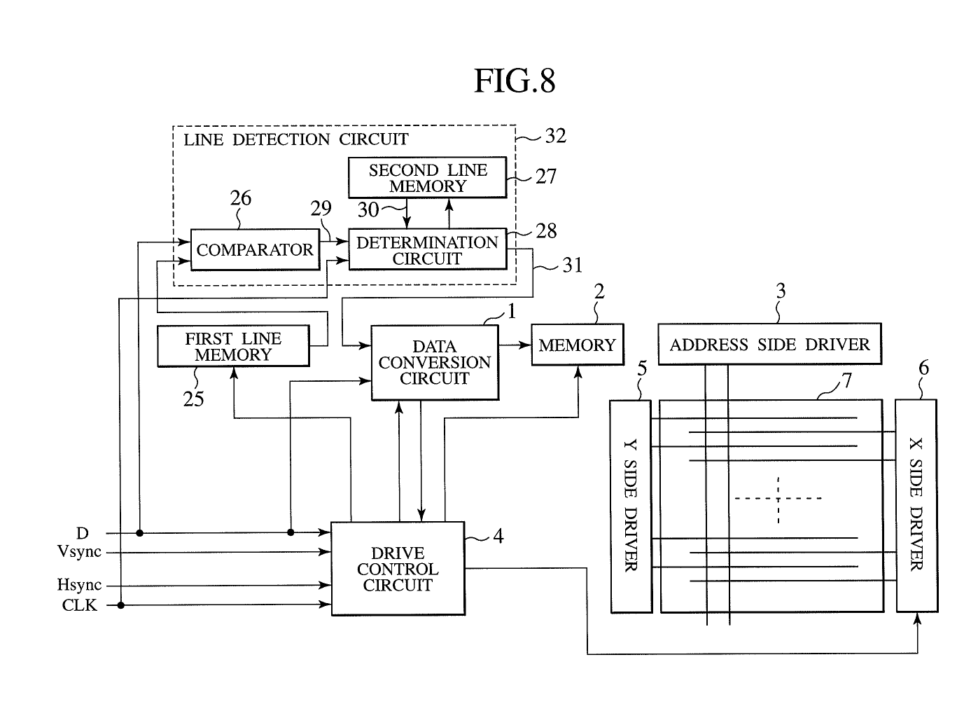

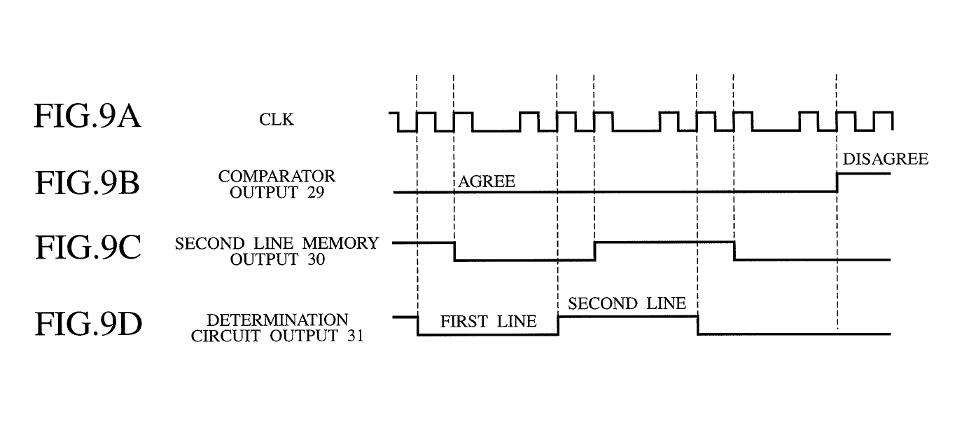

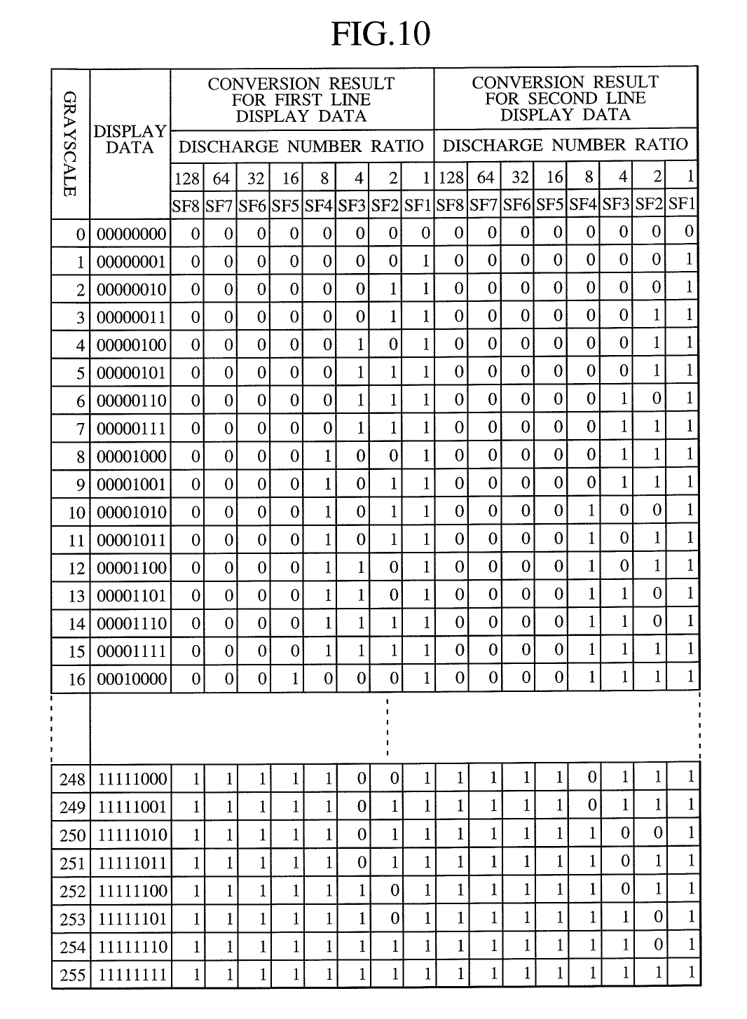

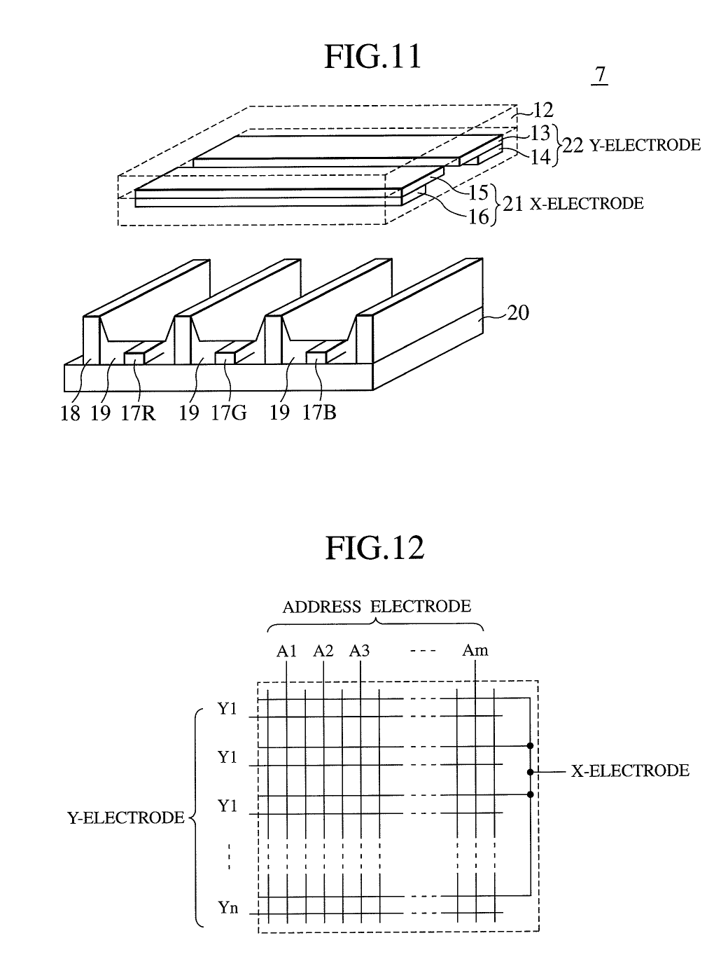

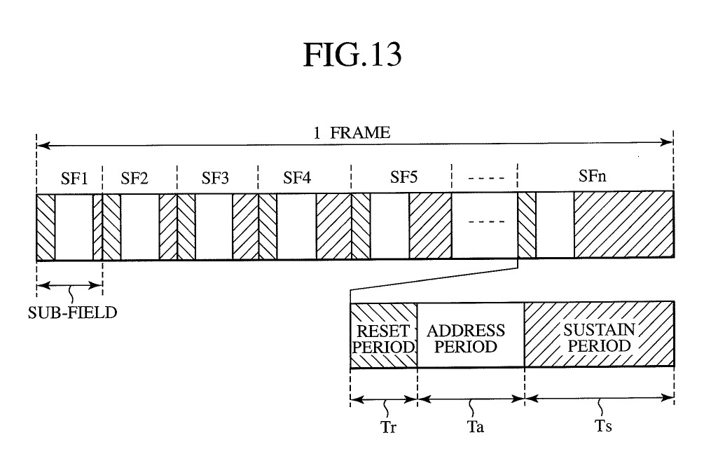

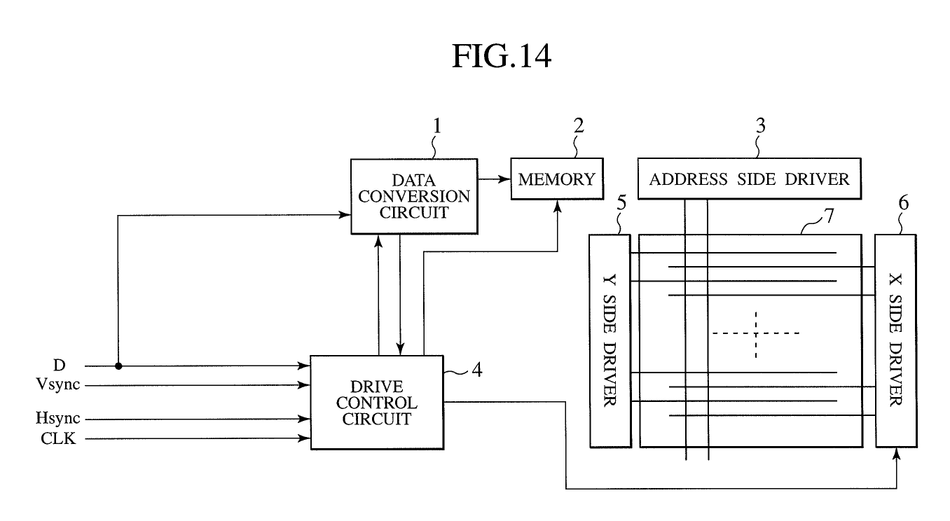

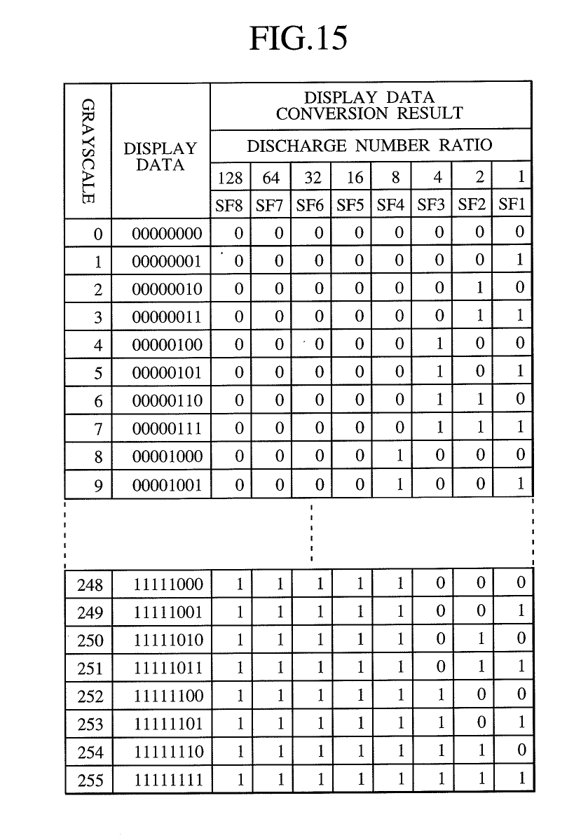

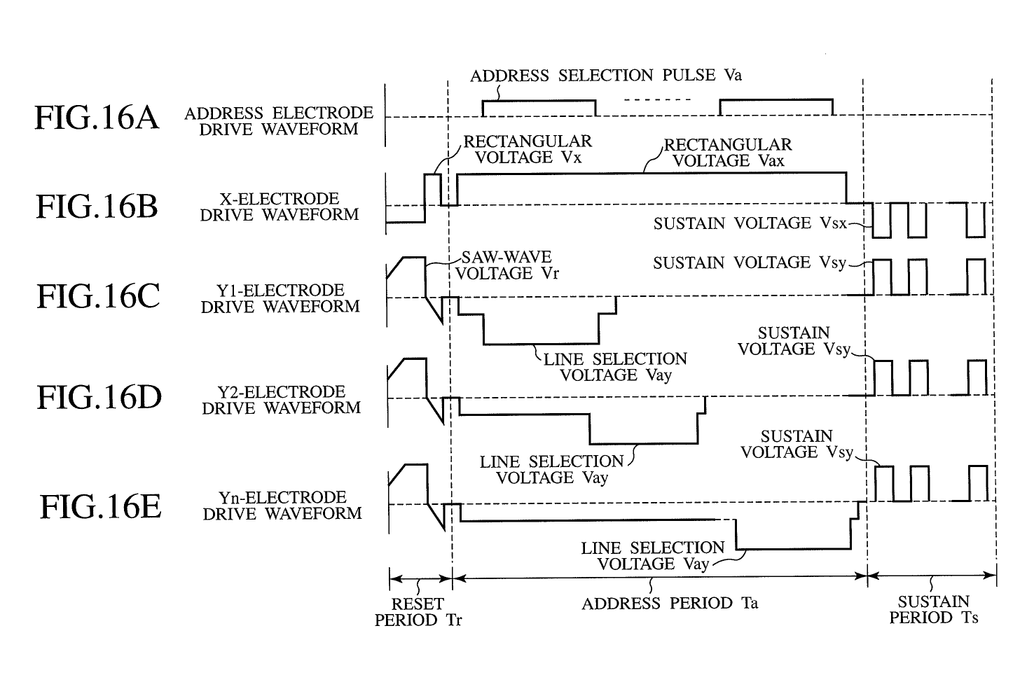

FIG. 8 to FIG. 10 are views illustrating a video display device according to a second embodiment of the present invention. FIG. 8 is a block diagram illustrating the video display device according to the second embodiment of the present invention, FIG. 9 is a view illustrating a waveform in a line detection circuit in the video display device shown in FIG. 8; and FIG. 10 is a view illustrating a data conversion table in a data conversion circuit in the video display device shown in FIG. 8.

Also the video display device according to the second embodiment of the present invention has the configuration in which gradated video displays are provided by causing a cell as a pixel in each sub-field to emit light. In this example, display data for an inputted video image is converted to data specifically specified so that an addressing operation is performed within an address period or address periods for one or a plurality of sub-fields to be scanned first within a frame. Among the cells above, those to be lit are driven for an address discharge and a display discharge in each sub-field based on the converted data, and an image is displayed with a gray scale level corresponding to an average emission times of cells in two successive frames. By making cells for colors other than black, namely cells to be lit emit light in an address period or periods for one or a plurality of sub-fields to be scanned first within a line, the address discharge is performed in the state where primary particles in the cell space still remain by a quantity sufficient for suppressing fluctuation in the discharge periods and enabling an address discharge in the stable conditions without fail. As described above, by accurately carrying out an address discharge in the state where fluctuation in the discharge period is suppressed, it is possible to shorten an address period for each sub-field. Shortening of the address period eliminates the necessity for shortening the sustain period and also eliminates the necessity of reducing the number of sub-fields with degradation of displayed image prevented. Also the following description of the second embodiment of the present invention assumes that a PDP device is used as the video display device.

In FIG. 8, reference numeral 7 denotes a display panel as a display section; 1, a data conversion circuit for converting display data for an inputted video signal to display data based on the sub-field system which can be displayed on the display panel 7; 2, a memory as a storage unit; 3, an address side driver as a cell drive circuit or an address electrode drive circuit for driving each address electrode on the display panel; 5, a Y-size driver as a cell drive circuit or a display electrode drive circuit for driving Y electrodes on the display panel 7; 6, an X-side driver as a cell drive circuit or a display electrode drive circuit for driving X-electrodes on the display panel 7; and 4, a drive control circuit as a control circuit for controlling the drivers 3,5,6, the memory 2, the data conversion circuit, and the like. Inputted to the drive control circuit 4 are display data for brightness levels of three colors of red, blue, and green, a vertical sync signal Vsync indicating start of one frame, a horizontal sync signal Hsync indicating state of a line, a clock signal CLK and the like from a TV tuner or other related sections. The drive control circuit 4 generates write/read signals for writing or reading data to and from the memory 2 in synchronism with the vertical sync signal Vsync and the horizontal sync signal Hsyc. Furthermore the drive control circuit 4 generates a rest timing signal for generating a rectangular voltage Vx or a saw voltage Vr, a scan timing signal for generating a line selection voltage Vay, a sustain liming signal for generating sustain voltages Vsx. Vsv and the like in synchronism with the vertical sync signal Vsync and the horizontal sync signal Hsyc.

Furthermore, reference numeral 32 denotes a line detection circuit for detecting a first line or a second line among two successive lines; 25, a first line memory for sustaining image data D for one line according to a write signal from the drive control circuit 4; 26, a comparator provided within a line detection circuit 32 for comparing an output from the first line memory 25 with display data D; 27, a second line memory for storing therein data indicating whether an immediately previous line is in the first line state or in the second line state; 28, a determination circuit for determining whether the current line is in the first line state or in the second line state based on an output the comparator 26 as well as on an output from the second line memory; 29, an output from the comparator 26; 30, an output from the second line memory 27; and 31, an output from the termination circuit 28.

When it is determined based on a result of comparison in the comparator 26 that an output at the same address from the first line memory 25 on a line is different from contents of the display data D, the comparator 26 sets the current line in the first line state. The drive control circuit 4 controls the data conversion circuit 1, the memory 2, and the first line memory 25. In other words, the drive control circuit 4 controls the data conversion circuit 1 so that the data conversion circuit 1 can convert the display data D, based on a result of determination by the determination circuit 28 as well as on the conversion table, to data for an address operation to a cell on the display panel 7 during an address period or address periods for one or a plurality of sub-fields to be scanned within a line. Furthermore, the drive control circuit 4 controls the memory 2 so that the converted data is stored in the memory 2, and enables output of an address selection pulse during an address period or address periods for one ot a plurality of sub-fields.

The data conversion circuit 1 converts the inputted display data D to display data based on the sub-field system by referring to a preset conversion table. Two data conversion tables are provided in the data conversion circuit 1. The two conversion tables have, for instance, the contents as shown in FIG. 10 and are shared by two successive lines.

The same reference numerals as those used in FIG. 8 are assigned to the components shown in FIG. 8 which are referred to in the following description.

FIG. 9 is a view illustrating a signal waveform in each section of a line detection circuit 32 in the video display device shown in FIG. 8.

In FIG. 9, FIG. 9A shows a clock signal CLK; FIG. 9B, an output 29 from the comparator 26, FIG. 9C, an output from the second line memory, and FIG. 9D, an output 31 from the termination circuit 28. In the comparator 26, an output from the first line memory 25 is compared with the display data D according to a timing of the clock signal CLK. When it is determined based on a result of the comparison above that the output from the line memory 25 and the display data D are not identical, the output 29 from the comparator 26 is set high (“H”). When it is determined that they are not identical, the output 29 is set low (“L”). An output 30 from the second line memory 27 is rewritten with an output 31 from the determination circuit 28 according to a timing of the clock signal CLK. The output 31 from the determination circuit 28 is set “L”when it is determined based on the output 29 from the comparator 26 as well as on the output 30 from the second line memory 27 that the current line is in the first line state where an output from the first line memory 25 and the display data are identical to each other, and is set “H”when the current line is in the second line state in which an output from the first line memory 25 and the display data D are not identical to each other.

FIG. 10 is a view illustrating an example of a conversion table in the data conversion circuit 1 in the video display device shown in FIG. 8, and in this example, a first address selection in two successive lines (a first frame and a second frame) is performed in one sub-fields to be scanned first within each line. In FIG. 10, the sub-field which is scanned first is the sub-field SF1 at the lowermost position.

In FIG. 10, for instance, when display data D at a horizontal address on the current line is “00000110” and also the display data D at the same horizontal address in the immediately previous line outputted from the first line memory 25 is “00000110”, a result of determination by the comparator 26 indicates “coincidence”, and the output from the determination circuit 28 is set “L” for the first line state. Therefore, results of data conversion at the address in the sub-fields SF8 to SF1 are 0:0:0:0:0:1:1:1 respectively. Since the discharge time ratios for the sub-fields SF8 to SF1 are preset at 128:64:32:16:8:4:2:1 respectively, and the number of discharge times is 7 times in all. In this step, after display data for the immediately previous line is read out, the display data for the current screen is written by the drive control circuit 4 at the horizontal address. Furthermore, the first line state, which is a contents of the output 31 from the determination circuit 28, is written in the second line memory 27. When the display data at the horizontal address on the following line is “00000110”, the output from the comparator 26 indicates “coincidence”, and the output 30 from the second line memory 27 is in the first line state, so that the output 31 from the determination circuit 28 is set in the second line state. Therefore, results of data conversion at the horizontal address in the sub-fields SF8 to SF1 are 0:0:0:0:0:1:0:2, and the number of discharge times is 5 in all. As described above, the discharge times is changed once for every two lines and set at 0:1, and the average gray scale level is 6 (namely, (7+5)/2), and the displayed image has the gray scale level of “6”.

Furthermore, when display data for a screen is switched, for instance, the display data D is changed to “00001000”, because an input to the comparator 26 is different from the display data of “00000110” for an immediately previous line outputted from the first line memory 25. An output from the comparator 26 indicates “non-coincidence”. In the “non-coincidence” state, even when the output 30 from the second line memory 27 is in the first line state, the output 31 from the determination circuit 28 is still kept in the first line state. In this case, results of data conversion by the data conversion circuit 1 at the address in the sub-fields SF8 to SF1 are 0:0:0:0:1:0:0:0, and the number of discharge times is 8 in all. Therefore, also in this case, the discharge times is switched for each frame, and the average gray scale level is 7 (namely, (6+8)/2), and the display image has the gray scale level of “7”.

As shown in FIG. 10, a first address selection within a line is performed in the sub-field SF1 at the lowermost position which is scanned first in two successive lines (a first line and a second line). Therefore, even in a cell in which the number of primary particles has decreased after passage of a certain period of time from the discharge time point during a sustain period, discharge is performed during the sustain period in the sub-field SF1 at the lowermost position. Because of the feature, delay of an address discharge in the other sub-fields SF2 to SF8 is improved.

Also in the drive sequence in the video display device shown in FIG. 8, only an address period for the sub-field SF1 is set long, and an address period for each of the oher sub-fields SF2 to SF8 is set short. Therefore, the sustain period can be prolonged in proportion to a reduced time in the address period. Increase of the sustain period enables increase in a brightness level of an image, which in turn enables bright image display. Furthermore, shortening of an address period enables increase in the number of sub-fields. Increase in the number of sub-fields enables increase of gray scale levels in an image.

Also in the second embodiment of the present invention, like in the first embodiment described above, it is possible to effect the address discharge for addressing without fail by suppressing fluctuation of a discharge period and also to shorten an address period in a video display device. Because of the feature, it is possible to prevent degradation in quality of displayed images.

The first and second embodiments of the present invention correspond to a case in which a PDP device is used as a video display device. However, the video display device according to the present invention is not limited to the PDP device, and any type of video display devices, which provides gradated video displays by making a cell as a pixel emit light based on the sub-field system, is included within a scope of the present invention. Descriptions of the first and second embodiments assume a case in which 8 sub-fields SF1 to SF8 are used, but the present invention is not limited to this configuration, and the number of sub-fields may be 7 or below, or 9 or more.

What is claimed is:

1. A video display device for displaying an image by causing a pixel to emit light in each sub-field within a frame, the device comprising:
a display section having a plurality of pixels arrayed in a matrix;
a comparator for comparing inputted display data for a current frame with display data for an immediately previous frame or for comparing display data for a current line with display data for an immediately previous line;
a conversion circuit for converting the inputted data, based on a result of the comparison and on a conversion table, to data for an address operation on the pixels within a address period or address period for one or a plurality of sub-fields to be scanned first within a frame, or to data for the address operation on the pixels within a address period or address period for one or a plurality of sub-fields to be scanned first within a line; and
a drive circuit for driving the pixels to be lit in each sub-fields, based on the converted data, for an address discharge and display discharge,
wherein images each having a gray scale level corresponding to emission times or average emission times from pixels within two successive frames or to emission times or average emission times from pixels within two successive frames are displayed on the display section.

2. The video display device according to claim 1, wherein the conversion circuit sets a lowermost sub-field or some or all of a plurality of sub-fields including the lowermost sub-field as a sub-field or sub-fields to be scanned first.

3. The video display device according to claim 1, wherein the conversion circuit sets an address period or address periods for a portion or all of one or the plurality of sub-fields to be scanned first so that the address period or address periods are longer than address periods for other sub-fields.

4. A driver circuit for a video display device that displays an image by causing a pixel to emit light in each sub-field within a frame, the driver comprising:
a comparator for comparing display data for an inputted current frame with display data for an immediately previous frame or for comparing display data for a current line with display data for an immediately previous line;
a conversion circuit for converting the inputted data, based on a result of the comparison and on a conversion table, to data for an address operation on the pixels within a address period or address periods for one or a plurality of sub-fields to be scanned first within a frame, or to data for the address operation on the pixels within a address period or address periods for one or a plurality of sub-fields to be scanned first within a line;
a storage circuit for storing therein the converted data and for outputting an address selection pulse within an address period or address periods for the one or the plurality of sub-fields specified in the converted data;
an address electrode drive circuit for applying the address selection pulse for an address discharge to pixels to be lit on the display section;
a display electrode drive circuit for applying a pulse for display corresponding to each sub-field to cause the pixels, to which an address discharge has been made, to emit light during a sustain period; and
a control circuit for controlling the conversion circuit, the storage circuit, the address electrode drive circuit, and the display electrode.

5. The driver circuit for a video display device according to claim 4, wherein the conversion circuit sets a lowermost sub-field or some or all of a plurality of sub-fields including the lowermost sub-field as a sub-field or sub-fields to be scanned first.

6. The drive circuit for the video display device according to claim 4, wherein the conversion circuit sets an address period or address periods for one or some or all of a plurality of sub-fields so that the address period or address periods are longer than address periods of other sub-fields.

7. A video display method for video displaying by causing a pixel on a display section to emit light in a sub-field within a frame, the video display method comprising:
a first step of comparing display data for a current frame inputted as a video signal with display data for an immediately previous frame, or for comparing display data for a current line with display data for an immediately previous line;
a second step of converting the input display data, by referring to a preset conversion table and based on a result of the comparison, to data for an address operation on the pixels during an address period or address periods for one or a plurality of sub-fields to be scanned first within a frame, or to data for the address operation on the pixels during an address period or address periods for one or a plurality of sub-fields to be scanned first within a line;
a third step of storing the converted data;
a fourth step of generating an address selection pulse for address selection based on the stored data;
a fifth step of outputting the address selection pulse during an address period or address periods for the one or the plurality of sub-fields specified in the converted data;
a sixth step of applying the address selection pulse to the pixels in each sub-field to be lit on the display section; and
a seventh step of applying a display pulse to the pixels during a sustain period for each sub-field to cause the pixels to which an address discharge has been made to emit light;
wherein an image having a gray scale level corresponding to times of light emission or average times of light emission of the pixels in two successive frames or to times of light emission or average times of light emission of the pixels in two successive lines.

8. The video display method according to claim 7, wherein the sub-field or sub-fields scanned first in the second step is a lowermost sub-field or some or all of a plurality of lower sub-fields including the lowermost sub-field.

9. The video display method according to claim 7, wherein an address period or address periods for one or some of all of a plurality of sub-fields to be scanned first are set longer as compared with those for the other sub-fields in the second step.
